(19) United States
(12) Patent Application Publication
(10) Pub. No.: US 2025/0347352 A1
(43) Pub. Date: Nov. 13, 2025

(54) TEMPERATURE-SENSITIVE ELEMENT AND TEMPERATURE-PRESSURE SAFETY VALVE

(71) Applicant: ZHEJIANG HUAYI PRECISION MACHINERY CO., LTD., Zhuji City (CN)

(72) Inventors: Haifeng YAO, Zhuji City (CN); Xiaohao TAO, Zhuji City (CN)

(21) Appl. No.: 19/194,399

(22) Filed: Apr. 30, 2025

(30) Foreign Application Priority Data
May 10, 2024 (CN) 202421005830.9
May 10, 2024 (CN) 202421005833.2

(51) Int. Cl. F16K 31/00; F16K 17/04

(52) U.S. Cl. CPC F16K 31/002; F16K 17/0486

(57) ABSTRACT

Provided are a temperature-sensitive element and a temperature-pressure safety valve. The temperature-sensitive element includes an outer housing, a sealing mounting member, and a piston rod. A temperature-control medium is disposed within the outer housing; when the vacuum level within the outer housing reaches a preset vacuum level, the sealing mounting member is riveted into the outer housing, and the sealing mounting member is sealingly disposed on the temperature-control medium; the piston rod is disposed within the outer housing and positioned on the sealing mounting member. The temperature-pressure safety valve includes the above temperature-sensitive element and also includes a valve body and a pressure relief assembly. The valve body is provided with a container interface and a pressure relief port. The pressure relief assembly is disposed within the valve body and includes an abutting member and a sealing member for sealingly isolating the container interface from the pressure relief port.

### CROSS-REFERENCE TO RELATED APPLICATION

The present application claims priority to Chinese Patent Application No. 2024210058332, filed with the China National Intellectual Property Administration (CNIPA) on May 10, 2024, and to Chinese Patent Application No. 2024210058309, filed with the China National Intellectual Property Administration (CNIPA) on May 10, 2024, the disclosures of which are incorporated herein by reference in their entireties.

### TECHNICAL FIELD

The present invention relates to the technical field of safety valves, in particular, a temperature-sensitive element and a temperature-pressure safety valve.

### BACKGROUND

The temperature-sensitive element in a temperature-pressure safety valve typically includes an outer housing, paraffin wax, a sealing gasket, and a piston rod. In the conventional assembly process, paraffin wax is first loaded into the outer housing, followed by riveting the sealing gasket onto the paraffin wax, and then installing the piston rod onto the sealing gasket.

To ensure the sealing effectiveness of the sealing gasket, an exhaust hole is provided in the sealing gasket to discharge air trapped between the sealing gasket and the paraffin wax within the outer housing when the sealing gasket is riveted and assembled, thereby ensuring that the sealing gasket can fully seal and compress the paraffin wax. Correspondingly, a guide protrusion is provided on the surface of the piston rod that contacts the sealing gasket. When the piston rod is mounted onto the sealing gasket, the guide protrusion on the piston rod is inserted into the exhaust hole of the sealing gasket to seal it, ensuring the complete sealing effect of the sealing gasket on the paraffin wax.

However, this method of installing the sealing gasket has drawbacks. On one hand, it results in a more complex structure for both the sealing gasket and the piston rod, increasing processing costs. On the other hand, during the process of riveting and assembling the sealing gasket, the exhaust hole in the sealing gasket is prone to deformation and eccentricity. When the piston rod is assembled, the eccentricity of the exhaust hole can lead to poor sealing of the exhaust hole by the guide protrusion, increasing the risk of paraffin wax leakage over prolonged use and reducing the service life of the temperature-sensitive element.

In view of the above problems, there is an urgent need for a temperature-sensitive element and a temperature-pressure safety valve to address these problems.

### SUMMARY

An object of the present invention is to provide a temperature-sensitive element that ensures effective sealing of a temperature-control medium, thereby improving the service life of the temperature-sensitive element while reducing the processing costs of the sealing mounting member and piston rod. Additionally, the present invention provides a temperature-pressure safety valve that prevents the push rod from puncturing the abutting member during prolonged use, enhances the service life of the abutting member, and ensures timely pressure relief activation.

To achieve these objects, the present invention adopts the following technical solutions:

A temperature-sensitive element is provided. The temperature-sensitive element includes an outer housing, a sealing mounting member, and a piston rod.

A temperature-control medium is disposed within the outer housing.

When the vacuum level within the outer housing reaches a preset vacuum level, the sealing mounting member is riveted into the outer housing, and the sealing mounting member is sealingly disposed on the temperature-control medium.

The piston rod is disposed within the outer housing and positioned on the sealing mounting member.

As an optional solution, the piston rod abuts and fits closely against the sealing mounting member.

As an optional solution, the sealing mounting member is a sealing gasket or a sealing ball.

As an optional solution, the temperature-sensitive element also includes a push rod.

One end of the push rod abuts the top end of the piston rod, another end of the push rod extends outside the outer housing, and the piston rod is configured to push the push rod upward along a Z-axis under the liquefaction action of the temperature-control medium.

As an optional solution, one end of the push rod is connected to a cylindrical boss, and the cylindrical boss is sealingly disposed within the outer housing and coaxially abuts the top end of the piston rod.

As an optional solution, the temperature-sensitive element also includes a first elastic member and a fixed seat.

The first elastic member is sleeved on the push rod, and one end of the first elastic member abuts the cylindrical boss.

The fixed seat is fixedly disposed within the outer housing and sleeved on the push rod, and another end of the first elastic member abuts the fixed seat.

As an optional solution, the outer diameter of the fixed seat is greater than the inner diameter of the outer housing such that the fixed seat is interference-fitted into the outer housing through an opening in the outer housing, and another end of the push rod extends outside the outer housing through the opening.

As an optional solution, the material of the outer housing is a thermally conductive material.

A temperature-pressure safety valve is provided. The temperature-pressure safety valve includes a valve body, a pressure relief assembly, and the temperature-sensitive element as described above.

The valve body is provided with a container interface and a pressure relief port.

The pressure relief assembly is disposed within the valve body; the pressure relief assembly includes an abutting member and a sealing member for sealingly isolating the container interface from the pressure relief port, the abutting member is a metal piece, and the sealing member is a rubber piece.

One end of the temperature-sensitive element passes through the container interface and is connected within the valve body, and the push rod of the temperature-sensitive element is configured to move upward along the Z-axis to abut the abutting member, thereby pushing the pressure relief assembly upward along the Z-axis to connect the container interface with the pressure relief port.

As an optional solution, the abutting member includes a first plate, a second plate, and a connecting boss, the connecting boss is connected between the first plate and the second plate, the sealing member has a disc-shaped structure, and the sealing member passes through the second plate and is sleeved on the connecting boss such that the sealing member is confined between the first plate and the second plate.

A communication port is disposed within the valve body, the communication port is configured to connect or isolate the container interface and the pressure relief port, the second plate is located at the communication port, and the sealing member sealingly abuts the outer peripheral edge of the communication port.

As an optional solution, the outer peripheral side of the second plate is inclined such that the outer peripheral side of the second plate is guided by an inclined edge of the communication port to move to the communication port, and the inclined edge of the communication port is in communication with the outer peripheral edge.

As an optional solution, the pressure relief assembly also includes a sealing seat.

The sealing seat is located within the valve body, the abutting member is mounted within the sealing seat, and the sealing member is located within the sealing seat.

As an optional solution, the pressure relief assembly also includes a valve stem.

One end of the valve stem is limitingly connected within the sealing seat, and another end of the valve stem extends out of the valve body and is operatively connected to a handle.

As an optional solution, the pressure relief assembly also includes a valve cap and a second elastic member.

The valve cap is sealingly and fixedly disposed within the valve body, and the valve stem sealingly passes through the valve cap.

The second elastic member is sleeved on the valve stem, and two ends of the second elastic member abut the sealing seat and the valve cap, respectively.

The temperature-pressure safety valve also includes a fixing member.

The fixing member is fixedly mounted within the valve body and is configured to fix the outer housing.

As an optional solution, the fixing member includes a first arcuate plate and a second arcuate plate.

Opposite sides of the first arcuate plate are separately connected to the second arcuate plate, the first arcuate plate has a snap-fit groove, the outer housing is interference-fitted into the snap-fit groove, an elastic deformation space is formed between the first arcuate plate and the second arcuate plate, and the second arcuate plate interference-abuts the inner wall surface of the valve body.

As an optional solution, the top end of the outer housing is provided with an annular boss, and when the outer housing is inserted into the snap-fit groove, the top end surface of the first arcuate plate abuts the bottom end surface of the annular boss.

As an optional solution, the temperature-pressure safety valve also includes a cover plate.

The cover plate sealingly covers an opening of the valve body and is provided with an information parameter of the temperature-pressure safety valve.

The present invention has the beneficial effects described below.

The temperature-control medium is first loaded into the outer housing, then the outer housing is subjected to a vacuum process, or the outer housing is placed in a vacuum environment until the vacuum level within the outer housing reaches a preset vacuum level, and after that, the sealing mounting member is riveted into the outer housing and is sealingly disposed on the temperature-control medium. In this manner, it is ensured that the sealing mounting member is sealingly and tightly compressed against the temperature-control medium to avoid the risk of leakage of the temperature-control medium. The piston rod is then installed within the outer housing and positioned on the sealing mounting member. Since the sealing mounting member is riveted onto the temperature-control medium under vacuum conditions, the sealing compression between the sealing mounting member and the temperature-control medium is ensured. As a result, there is no need to provide an exhaust hole in the sealing mounting member, nor a corresponding guide protrusion on the piston rod's contact surface with the sealing mounting member to seal the exhaust hole. This arrangement simplifies the structure of the sealing mounting member and piston rod, facilitating processing and reducing costs. Additionally, this arrangement ensures that the sealing effect of the sealing mounting member is not compromised during the assembly process between the piston rod and the sealing mounting member, maintaining a robust seal on the temperature-control medium and preventing the risk of leakage of the temperature-control medium over prolonged use, thereby enhancing the service life of the temperature-sensitive element.

The temperature-pressure safety valve of the present invention, due to the inclusion of the above-described temperature-sensitive element, has a simple structure, which reduces processing costs. Moreover, its good sealing performance effectively prevents the risk of temperature-control medium leakage, which enhances the service life of the temperature-pressure safety valve. Additionally, the pressure relief assembly is configured to include an abutting member and a sealing member for sealingly isolating the container interface and the pressure relief port on the valve body. Thus, when the temperature-sensitive element detects a high temperature in the container, the push rod of the temperature-sensitive element is capable of moving upward along the Z-axis to abut the abutting member, thereby enabling the push rod to push the abutting member and thus drive the entire pressure relief assembly upward along the Z-axis to connect the container interface with the pressure relief port, achieving pressure relief within the container. Since the sealing member is a rubber piece, the sealing member ensures an effective sealing isolation between the container interface and the pressure relief port. Meanwhile, since the abutting member is a metal piece, on the one hand, the abutting member prevents the push rod from puncturing the abutting member during prolonged use, thereby improving the service life of the abutting member; on the other hand, due to the rigidity of the abutting member, no pre-compression occurs when the push rod contacts the abutting member, allowing the push rod to promptly push the entire pressure relief assembly upward, eliminating the time delay caused by pre-compression, and thus ensuring a more timely pressure relief activation.

### BRIEF DESCRIPTION OF DRAWINGS

FIG. 1 is a schematic view of the assembly structure between a valve body and a temperature-sensitive element according to the present invention.

FIG. 2 is a first schematic view of the structure of a temperature-sensitive element according to the present invention.

FIG. 3 is a sectional view of a temperature-sensitive element according to the present invention.

FIG. 4 is a second schematic view of the structure of a temperature-sensitive element (excluding the outer housing) according to the present invention.

FIG. 5 is a sectional view of a temperature-pressure safety valve according to the present invention.

FIG. 6 is a first schematic view of the structure of a pressure relief assembly according to the present invention.

FIG. 7 is a schematic view of the assembly structure between an abutting member and a sealing member according to the present invention.

FIG. 8 is a schematic view of the structure of an abutting member and a sealing member before assembly according to the present invention.

FIG. 9 is a schematic view of the structure when a sealing member does not seal a communication port according to the present invention.

FIG. 10 is a partially enlarged schematic view of portion A in FIG. 9.

FIG. 11 is a second schematic view of the structure of a pressure relief assembly according to the present invention.

FIG. 12 is a schematic view of the assembly structure between a temperature-sensitive element and a fixing member according to the present invention.

### Reference List

10 valve body
11 container interface
12 pressure relief port
13 communication port
131 outer peripheral edge
132 inclined edge
1 outer housing
110 opening
2 sealing mounting member
3 piston rod
4 push rod
41 cylindrical boss
5 first elastic member
6 fixed seat
7 temperature-control medium
20 pressure relief assembly
21 abutting member
211 first plate
212 second plate
2121 outer peripheral side
213 connecting boss
22 sealing member
23 sealing seat
24 valve stem
25 handle
26 valve cap
27 second elastic member
30 fixing member
31 first arcuate plate
32 second arcuate plate
33 elastic deformation space
34 snap-fit groove
40 cover plate
50 sealing gasket
60 temperature-sensitive element
101 annular boss

### DETAILED DESCRIPTION

All features disclosed in this specification, or all steps of any method or process disclosed, may be combined in any manner except where such features and/or steps are mutually exclusive.

Any feature disclosed in this specification, unless specifically stated otherwise, may be replaced by other equivalent or similarly purposed alternative features. That is, unless otherwise stated, each feature is only one example of a series of equivalent or similar features. Throughout the specification, the same reference numerals denote the same elements.

To clarify the technical problems addressed by the present invention, the technical solutions adopted, and the technical effects achieved, the technical solutions of the present invention are further described below with reference to the accompanying drawings and specific embodiments.

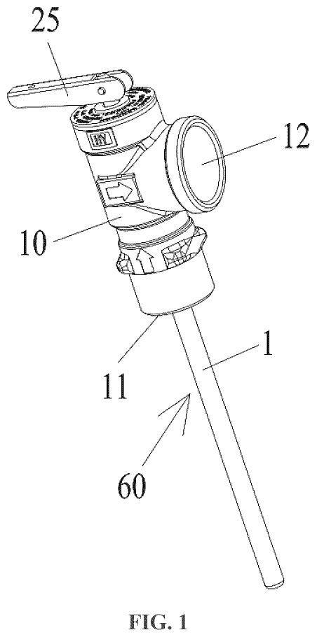

This embodiment proposes a temperature-sensitive element and a temperature-pressure safety valve incorporating the same. As shown in FIG. 1, the temperature-pressure safety valve also includes a valve body 10 and a pressure relief assembly disposed within the valve body 10. The valve body 10 is provided with a container interface 11 and a pressure relief port 12. The container interface 11 is configured to connect to a container, with the temperature-sensitive element positioned within the container to sense the temperature in the container. When detecting an excessively high temperature in the container, the temperature-sensitive element pushes the pressure relief assembly upward along the Z-axis, connecting the container interface 11 with the pressure relief port 12 to relieve pressure within the container. In this embodiment, the container may specifically be a water container.

Specifically, as shown in FIGS. 1 to 4, the temperature-sensitive element 60 includes an outer housing 1, a sealing mounting member 2, and a piston rod 3; a temperature-control medium 7 is disposed within the outer housing 1; when the vacuum level within the outer housing 1 reaches a preset vacuum level, the sealing mounting member 2 is riveted into the outer housing 1, sealingly compressing the temperature-control medium 7; the piston rod 3 is disposed within the outer housing 1 and positioned on the sealing mounting member 2. In this embodiment, the temperature-control medium 7 may specifically be paraffin wax.

Compared to the prior art, the temperature-sensitive element of this embodiment modifies the riveting assembly method of the sealing mounting member 2 and simplifies the structures of the sealing mounting member 2 and piston rod 3 accordingly. The temperature-control medium 7 is first loaded into the outer housing 1, then the outer housing 1 is subjected to a vacuum process, or the outer housing 1 is placed in a vacuum environment until the vacuum level within the outer housing 1 reaches a preset vacuum level, and after that, the sealing mounting member 2 is riveted into the outer housing 1 and is sealingly disposed on the temperature-control medium 7. In this manner, it is ensured that the sealing mounting member 2 is sealingly and tightly compressed against the temperature-control medium 7 to avoid the risk of leakage of the temperature-control medium 7. The piston rod 3 is then installed within the outer housing 1 and positioned on the sealing mounting member 2. Since the sealing mounting member 2 is riveted onto the temperature-control medium 7 under vacuum conditions, the sealing compression between the sealing mounting member 2 and the temperature-control medium 7 is ensured. As a result, there is no need to provide an exhaust hole in the sealing mounting member 2, nor a corresponding guide protrusion on the piston rod 3's contact surface with the sealing mounting member 2 to seal the exhaust hole. This arrangement simplifies the structure of the sealing mounting member 2 and piston rod 3, facilitating processing and reducing costs. Additionally, this arrangement ensures that the sealing effect of the sealing mounting member 2 is not compromised during the assembly process between the piston rod 3 and the sealing mounting member 2, maintaining a robust seal on the temperature-control medium 7 and preventing the risk of leakage of the temperature-control medium 7 over prolonged use, thereby enhancing the service life of the temperature-sensitive element.

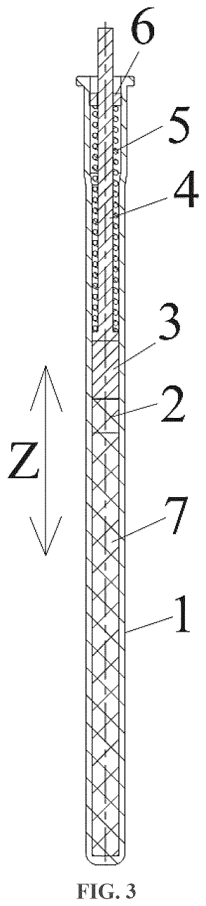

Specifically, since no exhaust hole is required in the sealing mounting member 2 and no guide protrusion is needed on the piston rod 3, the contact surfaces of the sealing mounting member 2 and piston rod 3 can fully abut and fit closely together, thus further improving the sealing effect between the sealing mounting member 2 and the piston rod 3, as shown in FIG. 3.

Further, the temperature-sensitive element 60 also includes a detection member (not shown) for detecting the vacuum level within the outer housing 1, ensuring that the vacuum level in the outer housing 1 reaches the preset vacuum level. This arrangement facilitates smooth riveting of the sealing mounting member 2 onto the temperature-control medium 7, ensuring effective sealing compression between the sealing mounting member 2 and the temperature-control medium 7 and avoiding issues such as insufficient pressing of the sealing mounting member 2 or incomplete compression on the temperature-control medium 7. The specific value of the preset vacuum level is not limited, as long as it is ensured that the sealing mounting member 2 is sealingly compressed onto the temperature-control medium 7.

It is to be noted that after riveting the sealing mounting member 2 onto the temperature-control medium 7, the detection member can be removed from the outer housing 1, simplifying the structure of the temperature-sensitive element. The removed detection member can be reused, reducing costs. In this embodiment, the detection member may specifically be a vacuum sensor.

Further, the sealing mounting member 2 may be a sealing gasket or a sealing ball. No limitation is imposed on the specific structure of the sealing mounting member 2 as long as a sealing function is achieved. In this embodiment, the sealing mounting member 2 is specifically a sealing gasket, and correspondingly, the contact surface of the piston rod 3 with the sealing mounting member 2 is flat. If the sealing mounting member 2 is configured as a sphere, the contact surface of the piston rod 3 with the sealing mounting member 2 is curved, thereby ensuring full abutment and fit between the two surfaces of the piston rod 3 and the sealing mounting member 2.

Specifically, as shown in FIGS. 1 to 4, the temperature-sensitive element 60 also includes a push rod 4. One end of the push rod 4 abuts the top end of the piston rod 3, while another end of the push rod 4 extends outside the outer housing 1 to push the pressure relief assembly. The piston rod 3 can push the push rod 4 upward along the Z-axis under the liquefaction action of the temperature-control medium 7, enabling the push rod 4 to move the pressure relief assembly, thereby connecting the container interface 11 with the pressure relief port 12 to release heat or pressure from the container through the container interface 11, the interior of the valve body 10, and the pressure relief port 12 in sequence.

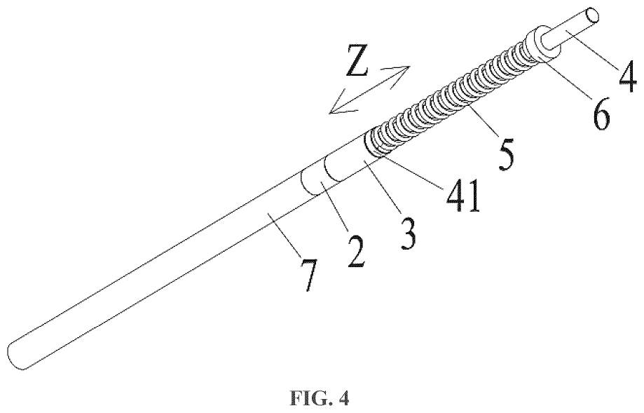

Specifically, as shown in FIGS. 3 and 4, one end of the push rod 4 is connected to a cylindrical boss 41, and the cylindrical boss 41 is sealingly disposed within the outer housing 1 and coaxially abuts the top end of the piston rod 3 to achieve a sealing effect for the cylindrical boss 41. This arrangement further prevents leakage of the temperature-control medium 7 via the cylindrical boss 41, enhancing the overall sealing performance of the temperature-sensitive element. In this embodiment, the push rod 4 and the cylindrical boss 41 are integrally formed.

Further, as shown in FIGS. 3 and 4, the temperature-sensitive element 60 also includes a first elastic member 5 and a fixed seat 6; the first elastic member 5 is sleeved on the push rod 4, and one end of the first elastic member 5 abuts the cylindrical boss 41; the fixed seat 6 is fixedly disposed within the outer housing 1 and sleeved on the push rod 4, and another end of the first elastic member 5 abuts the fixed seat 6 to confine the first elastic member 5 between the cylindrical boss 41 and the fixed seat 6. In this embodiment, the first elastic member 5 may specifically be a compression spring.

Specifically, when the temperature in the container rises, heat from the container is transferred through the outer housing 1 to the temperature-control medium 7, causing the temperature-control medium 7 to transition from a solid state to a liquid state. The volume of the temperature-control medium 7 expands within the outer housing 1, and this expansion force pushes the sealing mounting member 2, piston rod 3, and push rod 4 upward along the Z-axis. The push rod 4 then abuts and pushes the pressure relief assembly upward along the Z-axis, connecting the container interface 11 with the pressure relief port 12. At this point, since the fixed seat 6 remains stationary, the fixed seat 6 provides a blocking and limiting effect on the first elastic member 5, causing the first elastic member 5 to compress.

When the temperature in the container decreases, the temperature-control medium 7 transitions from a liquid state to a solid state at lower temperatures, reducing the volume of the temperature-control medium 7 within the outer housing 1. Under the elastic force of the first elastic member 5, the push rod 4, piston rod 3, and sealing mounting member 2 move downward along the Z-axis, achieving an automatic reset function. Without the pushing force of the push rod 4, the pressure relief assembly can also automatically reset, isolating the container interface 11 from the pressure relief port 12.

It is to be noted that the material of the outer housing 1 is a thermally conductive material to facilitate heat transfer between the container and the temperature-control medium 7 through the outer housing 1. This arrangement ensures timely transfer of heat from the container to the temperature-control medium 7, enabling the temperature-control medium 7 to change states based on the heat transferred to the outer housing 1, thus ensuring timely and accurate pressure relief for the container.

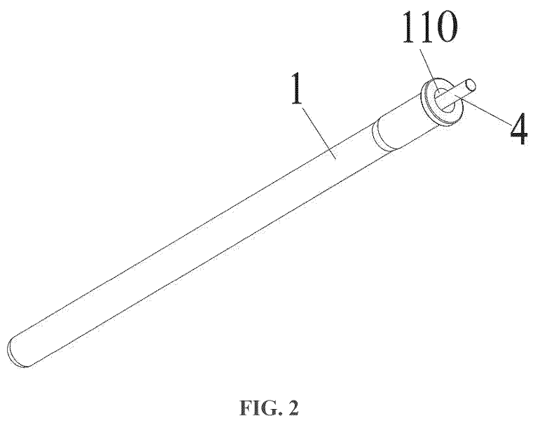

Further, as shown in FIGS. 2 to 4, the outer diameter of the fixed seat 6 is greater than the inner diameter of the outer housing 1, allowing the fixed seat 6 to be interference-fitted into the outer housing 1 through an opening 110 in the outer housing 1, thereby fixing the fixed seat 6 within the outer housing 1. This interference fit provides a simple and convenient method of securing the fixed seat 6 within the outer housing 1. Another end of the push rod 4 extends outside the outer housing 1 through the opening 110, facilitating the abutment of the push rod 4 with the pressure relief assembly.

It is to be noted that in this embodiment, the push rod 4 specifically abuts an abutting member in the pressure relief assembly, where the abutment member is made of metal. Compared to the prior art, where the push rod 4 abuts a rubber gasket in the pressure relief assembly, this configuration where the push rod 4 abuts the abutment member prevents the push rod 4 from puncturing the abutting member, enhancing the service life of the abutment member. Additionally, pre-compression upon contact between the push rod 4 and the abutting member is avoided, thereby ensuring timely pressure relief activation based on temperature and timely pressure relief of the temperature-pressure safety valve.

The assembly process of the temperature-sensitive element in this embodiment is as follows.

First, the temperature-control medium 7 is loaded into the outer housing 1. Then, in a vacuum environment, the sealing mounting member 2 is riveted onto the temperature-control medium 7, enabling the sealing mounting member 2 to seal the temperature-control medium 7. The piston rod 3 is then installed within the outer housing 1 on the sealing mounting member 2, followed by the push rod 4 being installed within the outer housing 1. The cylindrical boss 41 at one end of the push rod 4 abuts the top end of the piston rod 3, and another end of the push rod 4 extends outside the outer housing 1 through the opening 110.

Next, the first elastic member 5 is sleeved onto the push rod 4, and the fixed seat 6 is sleeved onto the push rod 4 and interference-fitted into the outer housing 1 through the opening 110 in the outer housing 1, securing the fixed seat 6 within the outer housing 1. This step completes the assembly process of the temperature-sensitive element.

In this embodiment, the temperature-sensitive element ensures that when the vacuum level within the outer housing 1 reaches a preset vacuum level, the sealing mounting member 2 is riveted into the outer housing 1 and is sealingly disposed on the temperature-control medium 7, thereby enabling the sealing mounting member 2 to be sealingly compressed against the temperature-control medium 7. This arrangement addresses the exhaust issue during the riveting assembly of the sealing mounting member 2, eliminating the need to provide an exhaust hole in the sealing mounting member 2 and a guide protrusion on the piston rod 3. As a result, the structures of the sealing mounting member 2 and the piston rod 3 are simplified, reducing processing costs. Furthermore, it is ensured that during the assembly process, the sealing mounting member 2 provides an effective sealing effect on the temperature-control medium 7, preventing the risk of leakage of the temperature-control medium 7, thereby enhancing the service life of the entire temperature-sensitive element.

A temperature-pressure safety valve typically includes a valve body, a temperature-sensitive element, and a pressure relief assembly. A portion of the temperature-sensitive element is located within the valve body, while another portion is positioned inside a container. The pressure relief assembly is disposed within the valve body. When the temperature-sensitive element is affected by the temperature inside the container, a push rod in the temperature-sensitive element moves upward along the Z-axis, causing the push rod to abut a rubber gasket in the pressure relief assembly and push the entire pressure relief assembly, thereby connecting the pressure relief port on the valve body with the container interface connected to the container to achieve pressure relief.

However, direct contact between the push rod of the temperature-sensitive element and the rubber gasket in the pressure relief assembly presents issues. On one hand, over prolonged use, the push rod may puncture the rubber gasket, leading to damage and leakage. On the other hand, due to the soft nature of the rubber gasket, initial contact between the push rod and the rubber gasket causes pre-compression, resulting in a time delay before the push rod can fully move the pressure relief assembly upward. This delay creates a discrepancy between the pressure relief activation time and the preset relief temperature, making the pressure relief response less timely.

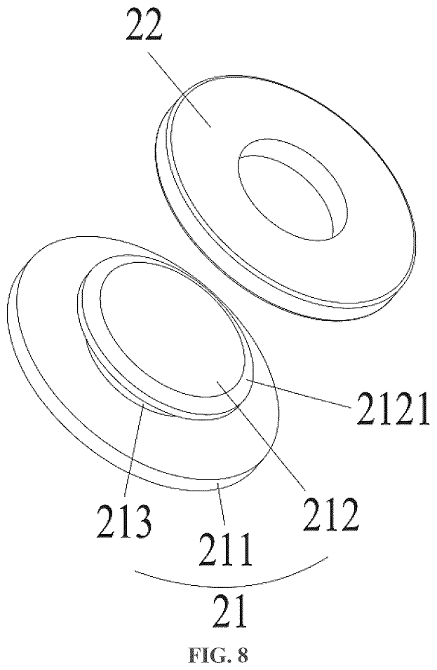

As shown in FIGS. 1 to 8, the embodiments of the present application also provide a temperature-pressure safety valve, the temperature-pressure safety valve includes a valve body 10, a pressure relief assembly 20, and the temperature-sensitive element 60 as described above. The valve body 10 is provided with a container interface 11 and a pressure relief port 12, and the container interface 11 is configured to connect to a container. The pressure relief assembly 20 is disposed within the valve body 10 and includes an abutting member 21 and a sealing member 22 for sealingly isolating the container interface 11 from the pressure relief port 12. The abutting member 21 is a metal piece, and the sealing member 22 is a rubber piece. One end of the temperature-sensitive element 60 passes through the container interface 11 and is connected within the valve body 10. The push rod 4 of the temperature-sensitive element 60 can move upward along the Z-axis to abut the abutting member 21, pushing the pressure relief assembly 20 upward along the Z-axis to connect the container interface 11 with the pressure relief port 12, thus achieving pressure relief within the container. In this embodiment, the container may specifically be a water container in a pressure-bearing solar water heater, electric water heater, or gas water heater.

Compared to the prior art, the temperature-pressure safety valve of this embodiment incorporates a metal abutting member 21. The pressure relief assembly 20 includes the abutting member 21 for abutment and the sealing member 22 for sealingly isolating the container interface 11 and pressure relief port 12 on the valve body 10. When the temperature-sensitive element 60 detects a high temperature in the container, the push rod of 4 the temperature-sensitive element 60 is capable of moving upward along the Z-axis to abut the abutting member 21. Thus, by pushing the abutment member 21, the sealing member 22 and the entire pressure relief assembly 20 are pushed upward along the Z-axis to connect the container interface 11 with the pressure relief port 12, achieving pressure relief within the container. Since the sealing member 22 is a rubber piece, that is, the sealing member 22 is made of rubber material, the sealing member 22 ensures an effective sealing isolation between the container interface 11 and the pressure relief port 12. Meanwhile, since the abutting member 21 is a metal piece, that is, the abutment member 21 is made of metal material, on the one hand, the abutting member 21 prevents the push rod 4 from puncturing the abutting member 21 during prolonged use, thereby improving the service life of the abutting member 21; on the other hand, due to the rigidity of the abutting member 21, no pre-compression occurs when the push rod 4 contacts the abutting member 21, allowing the push rod 4 to promptly push the entire pressure relief assembly 20 upward, eliminating the time delay caused by pre-compression, and thus ensuring a more timely pressure relief activation.

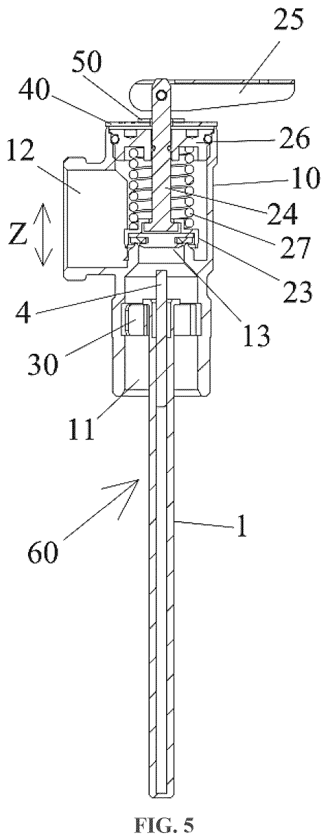

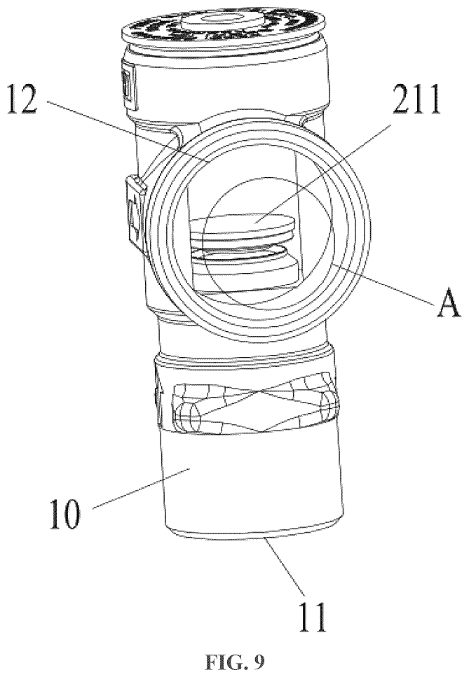

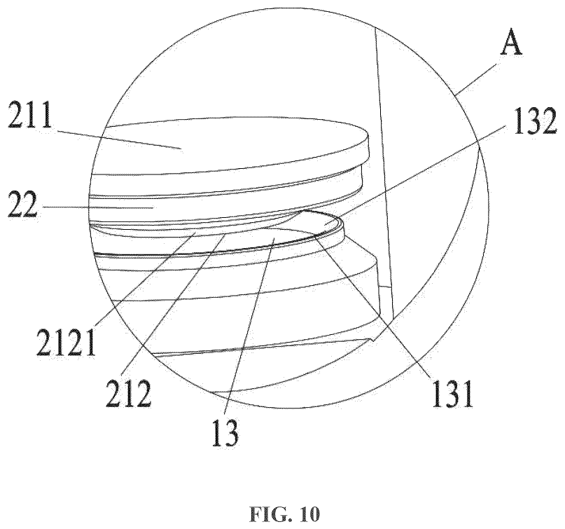

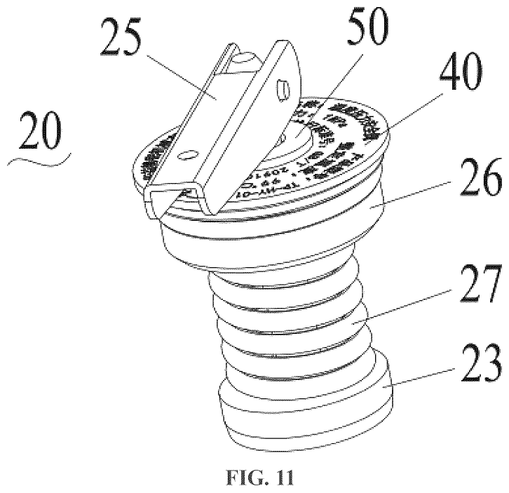

Further, as shown in FIGS. 5 to 8, the abutting member 21 includes a first plate 211, a second plate 212, and a connecting boss 213; the connecting boss 213 is connected between the first plate 211 and the second plate 212; the sealing member 22 has a disc-shaped structure, passes through the second plate 212, and is sleeved on the connecting boss 213, and the sealing member 22 abuts the first plate 211, thereby confining the sealing member 22 between the first plate 211 and the second plate 212 and mounting the sealing member 22 onto the abutting member 21. As shown in FIGS. 9 and 10, a communication port 13 is provided within the valve body 10 and is capable of connecting or isolating the container interface 11 and the pressure relief port 12; the second plate 212 is located at the communication port 13, allowing the push rod 4 to abut the second plate 212 when moving upward along the Z-axis; the sealing member 22 sealingly abuts the outer peripheral edge 131 of the communication port 13, sealing the communication port 13. The rubber material of the sealing member 22 ensures a robust sealing effect on the communication port 13. In this embodiment, the abutting member 21 is integrally formed, and the material of the abutting member 21 may specifically be stainless steel.

Specifically, as shown in FIGS. 7 to 10, the outer peripheral side 2121 of the second plate 212 is inclined so that the outer peripheral side 2121 of the second plate 212 is guided by the inclined edge 132 of the communication port 13 to move to the communication port 13. This mutually matched outer peripheral side 2121 and inclined edge provide guidance for assembling the second plate 212 to the communication port 13, facilitating ease of installation of the second plate 212 within the valve body 10. The inclined edge 132 of the communication port 13 communicates with the outer peripheral edge 131.

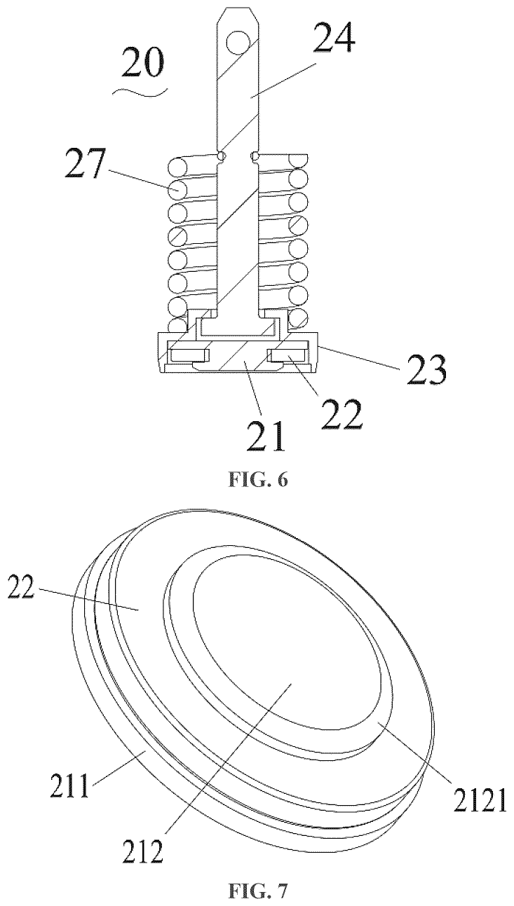

Further, as shown in FIGS. 5 and 6, the pressure relief assembly 20 also includes a sealing seat 23 located within the valve body 10. The sealing seat 23 is configured to mount the abutting member 21 and the sealing member 22. The first plate 211 of the abutting member 21 is interference-fitted into the sealing seat 23, fixing the abutting member 21 within the sealing seat 23, and the sealing member 22 is located within the sealing seat 23.

Specifically, as shown in FIGS. 5 and 6, the pressure relief assembly 20 also includes a valve stem 24; one end of the valve stem 24 is limitingly connected within the sealing seat 23, enabling synchronous movement of the sealing seat 23 and the valve stem 24; another end of the valve stem 24 extends out of the valve body 10 and is operatively connected to a handle 25. Rotating the handle 25 drives the valve stem 24 to move upward along the Z-axis, achieving manual pressure relief. The manual pressure relief process is a common operation in existing safety valves and is not described in detail here.

Further, as shown in FIGS. 5, 6, and 11, the pressure relief assembly 20 also includes a valve cap 26 and a second elastic member 27; the valve cap 26 is sealingly and fixedly disposed within the valve body 10, and the valve stem 24 sealingly passes through the valve cap 26; the second elastic member 27 is sleeved on the valve stem 24, and two ends of the second elastic member 27 abut the sealing seat 23 and the valve cap 26, respectively. The valve cap 26 is interference-fitted into the valve body 10 to achieve fixed setting of the valve cap 26 in the valve body 10. In this embodiment, the second elastic member 27 may specifically be a compression spring.

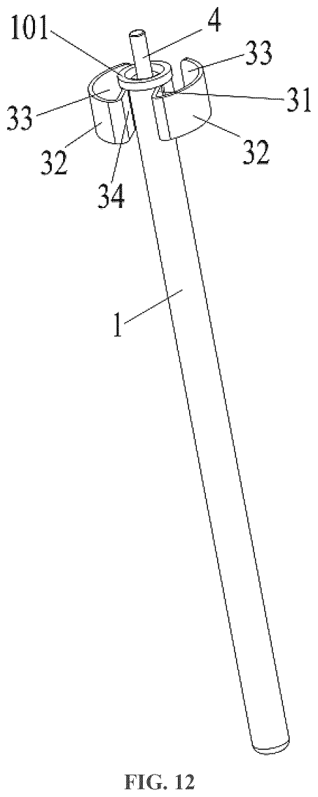

Specifically, as shown in FIGS. 5 and 12, the temperature-sensitive element 60 also includes an outer housing 1, one end of the push rod 4 is located within the outer housing 1, and another end of the push rod 4 extends outside the outer housing 1 into the valve body 10. The temperature-pressure safety valve also includes a fixing member 30. The fixing member 30 is fixedly mounted within the valve body 10 and is configured to fix the outer housing 1, thereby connecting the temperature-sensitive element 60 to the valve body 10.

Specifically, as shown in FIG. 12, the fixing member 30 includes a first arcuate plate 31 and a second arcuate plate 32; opposite sides of the first arcuate plate 31 are separately connected to the second arcuate plate 32; the first arcuate plate 31 has a snap-fit groove 34, the outer housing 1 is interference-fitted into the snap-fit groove 34, an elastic deformation space 33 is formed between the first arcuate plate 31 and the second arcuate plate 32, and the second arcuate plate 32 interference-abuts the inner wall surface of the valve body 10.

Specifically, when the fixing member 30 is installed in the valve body 10, the interference abutment of the second arcuate plate 32 against the inner wall surface of the valve body 10 causes elastic deformation of the second arcuate plate 32. Correspondingly, the elastic force of the second arcuate plate 32 presses the second arcuate plate 32 tightly against the inner wall surface of the valve body 10, ensuring secure and reliable abutment between the second arcuate plate 32 and the inner wall surface of the valve body 10. The elastic deformation space 33 between the first arcuate plate 31 and the second arcuate plate 32 provides room for the elastic deformation of the second arcuate plate 32, preventing interference between the second arcuate plate 32 and the first arcuate plate 31 during deformation.

In this embodiment, as shown in FIG. 12, the fixing member 30 is integrally formed to ensure stable and reliable connection between the first arcuate plate 31 and the second arcuate plate 32. The material of the fixing member 30 is specifically stainless steel, providing both elasticity and structural strength to ensure stable fixation of the outer housing 1.

Further, as shown in FIG. 12, the top end of the outer housing 1 is provided with an annular boss 101. When the outer housing 1 is inserted into the snap-fit groove 34, the top end surface of the first arcuate plate 31 abuts the bottom end surface of the annular boss 101, allowing the annular boss 101 to provide a limiting effect for the fixing member 30, thereby ensuring positional stability of the fixing member 30 within the valve body 10.

Specifically, as shown in FIGS. 5 and 11, the temperature-pressure safety valve also includes a cover plate 40 sealingly covering the opening of the valve body 10 to seal the opening of the cover plate 40. The cover plate 40 is provided with an information parameter of the temperature-pressure safety valve, that is, a nameplate recording the information parameter of the temperature-pressure safety valve is mounted on the cover plate 40. Additionally, a sealing gasket 50 is disposed on the cover plate 40 and is sleeved on the valve stem 24 to enhance the sealing effect between the valve stem 24 and the cover plate 40.

The specific operation process of the temperature-pressure safety valve in this embodiment is as follows:

First, when the temperature in the container rises, heat from the container is transferred through the outer housing 1 to the temperature-control medium 7, causing the temperature-control medium 7 to transition from a solid state to a liquid state. The volume of the temperature-control medium 7 expands within the outer housing 1, and this expansion force pushes the sealing member 2, piston rod 3, and push rod 4 upward along the Z-axis. The push rod 4 abuts the second plate 212 of the abutting member 21 along the Z-axis, pushing the second plate 212 to drive the sealing member 22, sealing seat 23, and valve stem 24 upward along the Z-axis. At this point, the sealing member 22 moves away from the outer peripheral edge 131 of the communication port 13 within the valve body 10, no longer sealing the communication port 13, thus connecting the container interface 11 with the pressure relief port 12 via the communication port 13 to relieve pressure in the container.

At this time, since the valve cap 26 remains stationary within the valve body 10, the valve cap 26 provides a blocking and limiting effect on the second elastic member 27, causing the second elastic member 27 to compress. Similarly, since the fixed seat 6 remains stationary, the fixed seat 6 provides a blocking and limiting effect on the first elastic member 5, causing the first elastic member 5 to compress.

When the temperature in the container decreases, the temperature-control medium 7 transitions from a liquid state to a solid state at lower temperatures, reducing the volume of the temperature-control medium 7 within the outer housing 1. Under the elastic force of the first elastic member 5, the push rod 4, piston rod 3, and sealing mounting member 2 move downward along the Z-axis, achieving an automatic reset function. Simultaneously, without the pushing force of the push rod 4 on the second plate 212 of the abutting member 21, the valve stem 24 and sealing seat 23 move downward along the Z-axis under the elastic force of the second elastic member 27, driving the second plate 212 of the abutting member 21 back to the communication port 13. The sealing member 22 sealingly abuts the outer peripheral edge 131 of the communication port 13, resealing the communication port 13 and isolating the container interface 11 from the pressure relief port 12.

In this embodiment, the temperature-pressure safety valve, by providing an abutting member 21 configured to match the push rod 4 and making the abutting member 21 of a metal material, enables the push rod 4 to abut the abutting member 21, thereby preventing the push rod 4 from puncturing the abutting member 21 and enhancing the service life of the abutting member 21. At the same time, pre-compression is prevented from occurring when the push rod 4 abuts the abutting member 21, thereby ensuring that pressure relief can be activated promptly based on temperature, thus ensuring the timeliness of pressure relief of the temperature-pressure safety valve.

The preceding content is only preferred embodiments of the present invention. For those of ordinary skill in the art, changes in specific implementations and application scopes exist according to the idea of the present invention, and the content of this specification should not be construed as a limitation to the present invention.

What is claimed is:

1. A temperature-sensitive element, comprising:
an outer housing, wherein a temperature-control medium is disposed within the outer housing;
a sealing mounting member, wherein when a vacuum level within the outer housing reaches a preset vacuum level, the sealing mounting member is riveted into the outer housing, and the sealing mounting member is sealingly disposed on the temperature-control medium;
a piston rod, disposed within the outer housing and positioned on the sealing mounting member; and
a push rod, wherein one end of the push rod abuts a top end of the piston rod, another end of the push rod extends outside the outer housing, and the piston rod is configured to push the push rod upward along a Z-axis under a liquefaction action of the temperature-control medium.

2. The temperature-sensitive element according to claim 1, wherein the piston rod abuts and fits closely against the sealing mounting member.

3. The temperature-sensitive element according to claim 1, wherein the sealing mounting member is a sealing gasket or a sealing ball.

4. The temperature-sensitive element according to claim 1, wherein the one end of the push rod is connected to a cylindrical boss, and the cylindrical boss is sealingly disposed within the outer housing and coaxially abuts the top end of the piston rod.

5. The temperature-sensitive element according to claim 4, further comprising:
a first elastic member sleeved on the push rod, wherein one end of the first elastic member abuts the cylindrical boss; and
a fixed seat fixedly disposed within the outer housing and sleeved on the push rod, wherein another end of the first elastic member abuts the fixed seat.

6. The temperature-sensitive element according to claim 5, wherein an outer diameter of the fixed seat is greater than an inner diameter of the outer housing such that the fixed seat is interference-fitted into the outer housing through an opening in the outer housing, and the another end of the push rod extends outside the outer housing through the opening.

7. The temperature-sensitive element according to claim 1, wherein a material of the outer housing is a thermally conductive material.

8. A temperature-pressure safety valve, comprising the temperature-sensitive element according to claim 1, and further comprising:
a valve body provided with a container interface and a pressure relief port;
a pressure relief assembly disposed within the valve body, wherein the pressure relief assembly comprises an abutting member and a sealing member for sealingly isolating the container interface from the pressure relief port, the abutting member is a metal piece, and the sealing member is a rubber piece; and
wherein one end of the temperature-sensitive element passes through the container interface and is connected within the valve body, and the push rod of the temperature-sensitive element is configured to move upward along the Z-axis to abut the abutting member, thereby pushing the pressure relief assembly upward along the Z-axis to connect the container interface with the pressure relief port.

9. The temperature-pressure safety valve according to claim 8, wherein the abutting member comprises a first plate, a second plate, and a connecting boss, the connecting boss is connected between the first plate and the second plate, the sealing member has a disc-shaped structure, and the sealing member passes through the second plate and is sleeved on the connecting boss such that the sealing member is confined between the first plate and the second plate; and
a communication port is disposed within the valve body, the communication port is configured to connect or isolate the container interface and the pressure relief port, the second plate is located at the communication port, and the sealing member sealingly abuts an outer peripheral edge of the communication port.

10. The temperature-pressure safety valve according to claim 9, wherein an outer peripheral side of the second plate is inclined such that the outer peripheral side of the second plate is guided by an inclined edge of the communication port to move to the communication port, and the inclined edge of the communication port is in communication with the outer peripheral edge.

11. The temperature-pressure safety valve according to claim 8, wherein the pressure relief assembly further comprises:
a sealing seat located within the valve body, wherein the abutting member is mounted within the sealing seat, and the sealing member is located within the sealing seat.

12. The temperature-pressure safety valve according to claim 11, wherein the pressure relief assembly further comprises:
a valve stem, wherein one end of the valve stem is limitingly connected within the sealing seat, and another end of the valve stem extends out of the valve body and is operatively connected to a handle.

13. The temperature-pressure safety valve according to claim 12, wherein the pressure relief assembly further comprises:
a valve cap sealingly and fixedly disposed within the valve body, wherein the valve stem sealingly passes through the valve cap; and
a second elastic member sleeved on the valve stem, wherein two ends of the second elastic member abut the sealing seat and the valve cap, respectively.

14. The temperature-pressure safety valve according to claim 8, further comprising:
a fixing member, wherein the fixing member is fixedly mounted within the valve body and is configured to fix the outer housing.

15. The temperature-pressure safety valve according to claim 14, wherein the fixing member comprises:
a first arcuate plate and a second arcuate plate, wherein opposite sides of the first arcuate plate are separately connected to the second arcuate plate, the first arcuate plate has a snap-fit groove, the outer housing is interference-fitted into the snap-fit groove, an elastic deformation space is formed between the first arcuate plate and the second arcuate plate, and the second arcuate plate interference-abuts an inner wall surface of the valve body.

16. The temperature-pressure safety valve according to claim 15, wherein a top end of the outer housing is provided with an annular boss, and when the outer housing is inserted into the snap-fit groove, a top end surface of the first arcuate plate abuts a bottom end surface of the annular boss.

17. The temperature-pressure safety valve according to claim 8, further comprising:
a cover plate, wherein the cover plate sealingly covers an opening of the valve body and is provided with an information parameter of the temperature-pressure safety valve.
